(19) United States
(12) Patent Application Publication
(10) Pub. No.: US 2026/0100765 A1
(43) Pub. Date: Apr. 9, 2026

(54) REPEATER SELECTION FOR QUANTUM COMMUNICATION NETWORKS

(71) Applicant: KING FAHD UNIVERSITY OF PETROLEUM AND MINERALS, Dhahran (SA)

(72) Inventor: Anas Mohamed Aatef Ata SALHAB, Dhahran (SA)

(73) Assignee: KING FAHD UNIVERSITY OF PETROLEUM AND MINERALS, Dhahran (SA)

(21) Appl. No.: 18/912,681

(22) Filed: Oct. 11, 2024

(30) Foreign Application Priority Data
Oct. 8, 2024 (SA) 1020245661

(51) Int. Cl. H04B 10/70; H04B 10/29

(52) U.S. Cl. CPC H04B 10/70; H04B 10/29

(57) ABSTRACT

A method and system for dual-hop quantum communication utilizing a quantum source node, a plurality of quantum repeaters, and a quantum receiver. The method involves transmitting, by a quantum source node teleporter, a message containing at least one superconducting qubit to multiple quantum repeaters over time-varying amplitude damping channels. Each quantum repeater measures a first hop relaxation time, estimates a second hop relaxation time, and calculates a minimum composite relaxation time. The minimum composite relaxation times are transmitted to the quantum source node, which selects the quantum repeater with the largest composite relaxation time to forward the message during the second hop. The selected quantum repeater transmits the message to the quantum receiver, establishing entanglement between repeater memory qubits and receiver memory qubits. The invention further includes methods for estimating quantum outage probabilities and utilizing error correction to ensure reliable quantum communication.

### CROSS REFERENCE TO RELATED APPLICATIONS

The present application claims the benefit of Saudi Patent Application No. 1020245661 filed on Oct. 8, 2024 with the Saudi Authority for Intellectual Property Office, which is incorporated herein by reference in its entirety.

### BACKGROUND

### Technical Field

The present disclosure is directed to the selection of quantum repeaters for quantum communication networks.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Quantum computing is playing an increasingly vital role in the field of telecommunications, offering capabilities that significantly surpass classical methods. These include the development of highly efficient algorithms, rapid computations, and secure communication systems. Unlike classical systems, governed by the principles of classical physics, quantum communication systems operate according to the principles of quantum mechanics, enabling phenomena such as superposition and entanglement. These unique quantum effects have paved the way for quantum-assisted communications, where quantum technologies augment classical communication protocols. Recently, attention has shifted toward fully quantum-based communication systems, which promise reduced data transmission rates while maintaining high levels of security and efficiency.

Despite these advances, quantum communication systems face considerable challenges, particularly in the form of errors generated during quantum information processing, storage, or transmission. These errors are primarily caused by environmental decoherence, which is a process in which quantum states lose their coherence due to interactions with their surroundings. Decoherence is a critical issue because it degrades quantum information, leading to errors in both quantum computations and communications. To mitigate decoherence, quantum error correction codes (QECCs) have been developed. QECCs are specifically designed to detect and correct quantum errors, thereby preserving the integrity of quantum information and enhancing the performance of quantum communication systems.

In both classical and quantum information processing, accurate channel models are essential for optimizing tasks such as data processing, storage, and transmission. In classical communications, extensive efforts have been made to develop sophisticated mathematical models for various types of communication channels, including both wireline and wireless environments. Similarly, in quantum communications, the effectiveness of QECCs depends heavily on precise models of quantum communication channels. These models account for the way in which various system parameters, such as relaxation time (T₁) and dephasing time (T₂), impact the overall performance of quantum communication systems.

One of the most widely recognized models for quantum channels is the noisy channel model, which describes the effects of decoherence on qubits, which are the fundamental units of quantum information. This model relies on key parameters such as T₁, which represents the relaxation time, and T₂, which represents the dephasing time, to capture the behavior of quantum channels accurately. These parameters serve as critical links between the physical qubits generated by quantum processors and the theoretical models used to describe and predict their behavior.

Conventional technologies for quantum communication channels have assumed that T₁ and T₂ are constant over time, leading to static channel models. However, recent experimental investigations have shown that T₁ and T₂ are not constant; instead, the experiments exhibit significant variations over time, with fluctuations of up to 50% from their mean values and coefficients of variation around 25% [See: J. J. Burnett et al. “Decoherence benchmarking of superconducting qubits,” npj Quantum Inf 5, 54 (2019); and A. Stehli et al, “Coherent superconducting qubits from a subtractive junction fabrication process,” Appl. Phys. Lett. 117, 124005 (2020), Y. Lu et al, “Quantum efficiency, purity and stability of a tunable, narrowband microwave single-photon source,” npj Quantum Inf 7, 140 (2021)]. These findings have prompted the development of more dynamic models that account for the time-varying nature of these parameters.

One such dynamic model is the time-varying quantum channel (TVQC) model, which has been developed to more accurately represent quantum channels by accounting for the temporal variations in T₁ and T₂. Within the TVQC framework, the time-varying amplitude damping (TVAD) model has been particularly effective in modeling quantum communication scenarios, such as those involving fiber-optic channels. The TVAD model is configured for qubits with negligible pure dephasing rates (T₁-limited), making it well-suited for wireline quantum communications.

The time-varying channel models, such as quantum outage probability and quantum hashing outage probability, have been the subject of experiments. The models represent asymptotically achievable error rates by QECCs operating over time-varying quantum channels. Closed-form expressions for QOP have been derived specifically for TVAD channels, and the models have proven effective in scenarios involving point-to-point quantum communication over significant distances, such as those encountered in fiber-optic and ground-to-satellite air links [See: C. Cicconetti et al, “Request scheduling in quantum networks,” IEEE Trans. Quantum Eng., vol. 2, pp. 4101917-4101917, 2021].

Quantum communication over long distances presents additional challenges, including the need to maintain the coherence of quantum states over tens or hundreds of kilometers. Practical limitations, such as short coherence times in quantum memories and signal power attenuation during transmission, particularly in fiber-optic and ground-to-satellite air links, complicate long-distance quantum communication. To overcome these challenges, quantum repeaters (QR) have been developed as a key technology within quantum networks. QRs enable secure quantum communications over extended distances by correcting quantum errors introduced by the quantum channel [See: A. S. Cacciapuoti et al, “Quantum internet: Networking challenges in distributed quantum computing,” IEEE Network, vol. 34, no. 1, pp. 137-143, 2020, 23; J. Yin et al., “Satellite-based entanglement distribution over 1200 kilometers,” Science, vol. 356, no. 6343, pp. 1140-1144, 2017].

Quantum repeaters are categorized into three main generations based on the error correction methods. The first generation of QRs utilizes heralded entanglement generation (HEG) and heralded entanglement purification (HEP) to address operation and loss errors, respectively. The second generation of QRs combines quantum error correction (QEC) with HEG to eliminate loss errors, while the third generation employs QEC to rectify both operation and loss errors. The QRs in quantum networks include a source, multiple repeaters, and a receiver.

The utilization of multiple repeaters in a quantum network enhances system performance by increasing the number of paths between the source and the receiver, thereby providing greater diversity and extending the coverage distance. However, the presence of multiple nodes in a quantum network introduces the need for effective node selection schemes and scheduling strategies. An entanglement-assisted path selection and node scheduling scheme include defining various metrics for path selection and evaluating them in combination with traditional algorithms, such as Dijkstra's shortest path first algorithm. However, existing path selection and node scheduling protocols have predominantly relied on entanglement among communicating nodes without considering the time variations in quantum channel parameters such as T₁.

WO2023128604A1 describes a method and device for performing error correction on asymmetric Pauli quantum channels. This method focuses on selecting the appropriate error correction code based on decoherence information, specifically T₁ and T₂, between two nodes communicating over the quantum channel. However, the method does not involve the use of repeaters between the nodes.

Each of the aforementioned references presents advancements in quantum communication technology but also possesses limitations in their scope and capability. The existing technologies do not address the practical need for an integrated system that combines time-varying quantum channel models with multiple quantum repeaters to guarantee the performance and security of quantum communication networks over long distances.

Thus, there exists a need for an integrated system to enhance the performance and secure communication management of quantum networks over long distances. There is also a need to determine a best repeater to use in the operation of quantum networks with time-varying quantum channel parameters. Accordingly, it is one of the objectives of the system and method to provide a system and method for selecting a quantum repeater from a plurality of quantum repeaters to transmit a signal based on real-time variations in relaxation time (T₁) and dephasing time (T₂) in order to promote secure, reliable, and efficient transmission of quantum information in quantum communication networks.

### SUMMARY

In an exemplary embodiment, a method for dual-hop quantum communication is described. The method comprises transmitting during a first hop, by a quantum source node teleporter, a message to a plurality K of quantum repeaters over a plurality of time-varying amplitude damping channels, where the message includes at least one superconducting qubit. The method further comprises receiving, by each quantum repeater i, where i=1, . . . , K, the message from the quantum source node. The method further comprises measuring, by each quantum repeater i, a first hop relaxation time T₁₍ᵢ₎¹. The method further comprises estimating, by each quantum repeater i, a second hop relaxation time T₁₍ᵢ₎² for transmitting the message from the quantum repeater i to a quantum repeater RQ, calculating, by each quantum repeater i, a minimum composite relaxation time T₁₍ᵢ₎, where T₁₍ᵢ₎ is given by T₁₍ᵢ₎=min(T₁₍ᵢ₎¹, T₁₍ᵢ₎²), and transmitting, by each quantum repeater i, the minimum composite relaxation time T₁₍ᵢ₎ to the quantum source node. The method further comprises determining, by the quantum source node, the largest composite relaxation time T_{1(best)} of the K quantum repeaters, where T_{1(best)} is given by T_{1(best)}=max(T₁₍ᵢ₎) for i=1, . . . , K, selecting, by the quantum source node, the quantum repeater with the largest composite relaxation time T_{1(best)}, transmitting, by the quantum source node, a control signal to the selected quantum repeater with the largest composite relaxation time T_{1(best)} to forward the message to the quantum repeater R_{Q} during the second hop, and transmitting, by the selected quantum repeater, the message to the quantum repeater R_{Q} during the second hop.

In another exemplary embodiment, a system for dual-hop quantum communication is disclosed. The system includes a quantum source node. The system further comprises a source encoder operatively connected within the quantum source node, where the encoder is configured to encode a message including at least one superconducting qubit. The system further comprises a plurality K of quantum repeaters, wherein each quantum repeater i, where i=1, . . . , K, includes at least one repeater memory qubit and a quantum repeater computing unit, a quantum source node teleporter operatively connected within the quantum source node, where the quantum source node teleporter is configured to transmit the message by establishing entanglement between the at least one superconducting qubit and the at least one repeater memory qubit. The system further includes a receiver configured with at least one receiver memory qubit. The system further includes the quantum repeater computing unit of each quantum repeater i, which includes a quantum repeater electrical circuitry, a quantum repeater transceiver, a quantum repeater teleporter, a quantum repeater electrical memory having quantum repeater program instructions and at least one quantum repeater processor configured to execute the quantum repeater program instructions to measure a first hop relaxation time T₁₍ᵢ₎¹, estimate a second hop relaxation time T₁₍ᵢ₎² for transmitting the message from the quantum repeater i to a quantum receiver R_{Q}, calculate a minimum composite relaxation time T₁₍ᵢ₎, where T₁₍ᵢ₎ is given by T₁₍ᵢ₎=min(T₁₍ᵢ₎¹, T₁₍ᵢ₎²), and transmit the minimum composite relaxation time T₁₍ᵢ₎ to the quantum source node. The system further comprises a quantum source computing unit operatively connected within the quantum source node, where the quantum source computing unit includes a quantum source electrical circuitry, a quantum source transceiver, a quantum source electrical memory having quantum source program instructions and at least one quantum source processor configured to execute the quantum source program instructions to receive the minimum composite relaxation time T₁₍ᵢ₎ from each quantum repeater i, select the quantum repeater with the largest composite relaxation time T_{1(best)}, and transmit a control signal to the selected quantum repeater with the largest composite relaxation time T_{1(best)} to forward the message to the quantum repeater R_{Q} during the second hop. The system further includes the quantum repeater teleporter, which is configured to transmit the message to the quantum repeater R_{Q} during the second hop by establishing entanglement between the at least one repeater memory qubit and the at least one receiver memory qubit.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a block diagram of a system to perform a dual-hop quantum communication network, according to certain embodiments.

FIG. 1B is a functional block diagram of a system for dual-hop quantum communication, according to certain embodiments.

FIG. 2 illustrates a flowchart of a method implemented for performing dual-hop quantum communication in a quantum network, according to certain embodiments.

FIG. 3 is a graphical representation illustrating a quantum outage probability as a function of a channel damping parameter γ under various system conditions, according to certain embodiments.

FIG. 4 is a graphical representation illustrating a detailed analysis of an impact of coefficients of variation ϵₐ and ϵ_{b} on a quantum outage probability, according to certain embodiments.

FIG. 5 is a graphical representation illustrating the quantum outage probability as a function of the channel damping parameter γ for various values of the number of quantum repeaters K, the source code rate Rₐ, and the repeater code rate R_{b}, according to certain embodiments.

FIG. 6 is a graphical representation illustrating the quantum outage probability as a function of the noise limit γl(R) for various values of the coefficient of variation ϵa and ϵb, and the number of quantum repeaters K, according to certain embodiments.

FIG. 7 is a three-dimensional graphical representation illustrating the Pₒᵤₜ^{Q} as a function of the code rate of the first hop (Rₐ) and the code rate of the second hop (R_{b}) for varying numbers of repeaters K, according to certain embodiments.

FIG. 8 is a graphical analysis determining the code rates required to achieve a specific target quantum outage probability, according to certain embodiments.

FIG. 9 is a graphical representation illustrating the quantum outage probability as a function of the channel damping parameter γ for three different types of quantum channels, according to certain embodiments.

FIG. 10 is an illustration of a non-limiting example of details of computing hardware used in the computing system, according to certain embodiments.

FIG. 11 is an exemplary schematic diagram of a data processing system used within the computing system, according to certain embodiments.

FIG. 12 is an exemplary schematic diagram of a processor used with the computing system, according to certain embodiments.

FIG. 13 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure are directed to a system, device, and method for dual-hop quantum communication. The system includes a quantum source node, multiple quantum repeaters, and a receiver. The quantum source node transmits a message, including at least one superconducting qubit, over time-varying amplitude damping channels to a plurality of quantum repeaters. Each quantum repeater measures a first hop relaxation time and estimates a second hop relaxation time for the transmission of the message. A composite relaxation time is calculated by each repeater, which is then transmitted back to the quantum source node. The quantum source node selects the quantum repeater with the largest composite relaxation time to forward the message to a designated quantum repeater during the second hop. The system further includes an error correction mechanism to estimate quantum outage probability and adjust transmission rates accordingly. The system is configured for managing non-selected repeaters and ensures desirable channel conditions are utilized by leveraging time-varying quantum channels. Additionally, the performance of the system is evaluated in terms of quantum outage probability (Pₒᵤₜ^{Q}) and quantum hashing outage probability (QHOP) for different quantum channel approximations, emphasizing the impact of various system parameters, including repeater count, code rates, and channel noise characteristics.

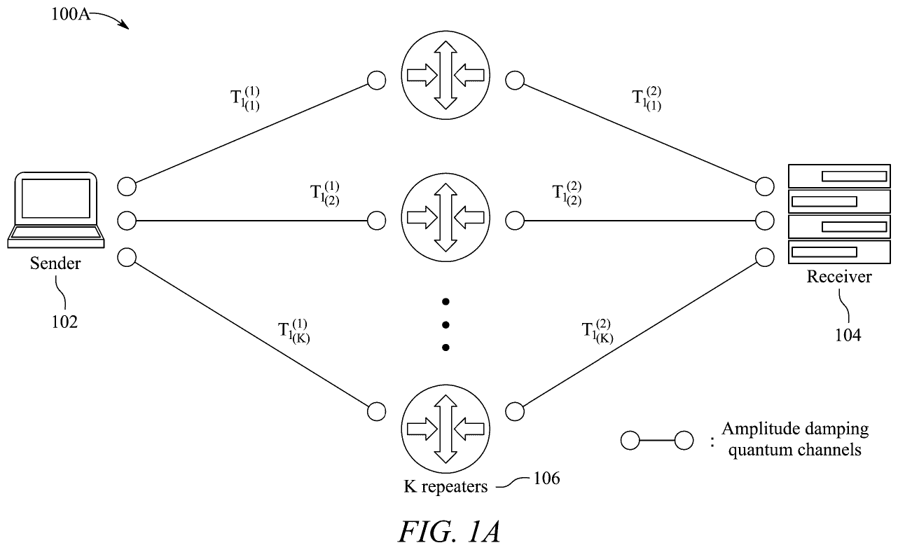

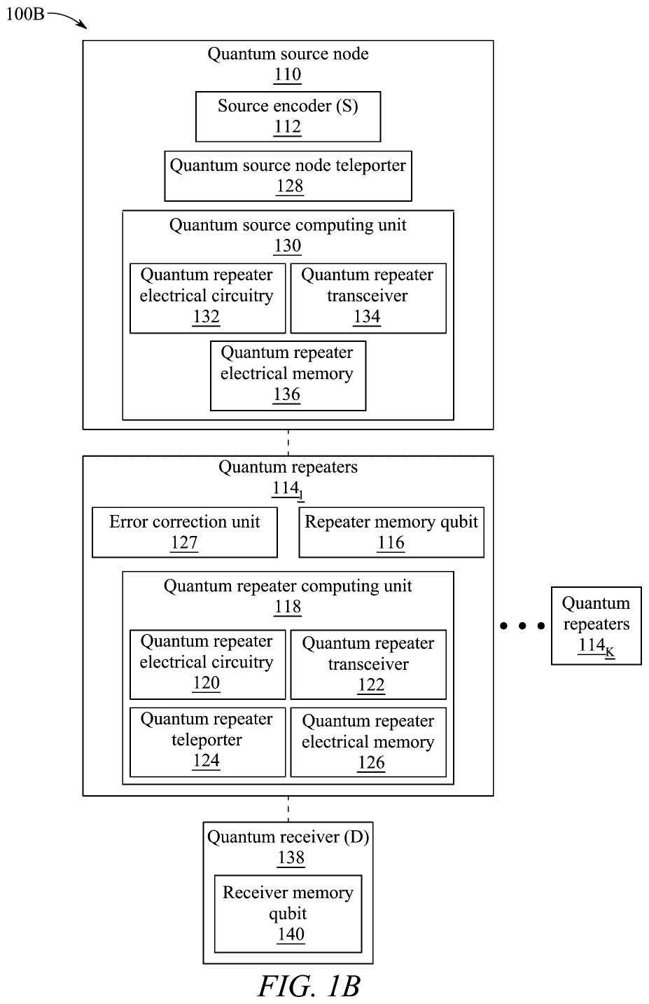

FIG. 1A illustrates a system 100A to perform dual-hop quantum communications in a dual-hop communication network. The dual-hop quantum communication network includes a quantum source or sender 102, a plurality of quantum repeaters (K) 106, and a receiver 104. The system 100A is configured based on asymptotical limits for the time-varying amplitude damping (TVAD) channel, which is used in modeling noisy wireline time-varying quantum channels, such as fiber-optic channels and internet communications.

The sender 102 initiates the quantum communication by transmitting a message that includes at least one superconducting qubit over the first set of TVAD quantum channels to the K quantum repeaters 106. Each quantum repeater 106, numbered as i, where i=1, . . . , K, receives the message and measures a first-hop relaxation time T₁₍ᵢ₎¹. The quantum repeater 106 estimates a second-hop relaxation time T₁₍ᵢ₎² for transmitting the message from the quantum repeater 106 to the receiver 104.

FIG. 1B illustrates a system 100B for dual-hop quantum communication. The system 100B is configured to facilitate the transmission of quantum information across two hops using a network of quantum repeaters 114, resulting in defined fidelity and defined decoherence during a communication process.

The system 100B includes a quantum source node 110, configured for transmitting messages in a dual-hop quantum communication network. The quantum source node 110 has a plurality of components operatively coupled within to perform transmission and receipt of quantum information across the network.

A source encoder 112 is operatively connected within the quantum source node 110. The source encoder 112 encodes a message and prepares information associated with the message in a format suitable for transmission through the quantum communication network. The encoded message includes at least one superconducting qubit. The source encoder 112 executes an encoding process to preserve the quantum state during transmission and involves generating quantum error correction codes or using other encoding mechanisms suited for quantum information. The encoding process may vary based on the quantum communication network implementations while protecting the information integrity of the qubit against potential noise or decoherence during transmission through quantum channels.

The system 100B includes a plurality of quantum repeaters 114, where each quantum repeater i, where i=1, . . . , K. The quantum repeater is a communication component of the quantum communication networks designed to extend a range over which quantum information (for example, the message) can be transmitted without degradation. Each quantum repeater 114 is configured to receive the transmitted message from the quantum source node 110 and teleport the message to a quantum receiver 138. Each quantum repeater 114 includes at least one repeater memory qubit 116 for storing the received qubit, ensuring that the quantum information is preserved during the relay process. The quantum repeaters 114 have the ability to extend the range of quantum communication by effectively acting as intermediaries between the quantum source node 110 and the quantum receiver 138. Each of the quantum repeaters 114 includes a quantum repeater computing unit 118.

The quantum source node 110 includes a quantum source node teleporter 128 which is operatively connected within the quantum source node 110. The quantum source node teleporter 128 is configured for establishing entanglement between the superconducting qubit and the repeater memory qubit 116 within the quantum repeaters 114. The superconducting qubit is a type of qubit used in quantum computing and quantum communication, operating at very low temperatures, where materials exhibit superconductivity, i.e., zero electrical resistance. The repeater memory qubit 116 is a qubit stored within the memory of the quantum repeater 114.

The quantum repeater computing unit 118 includes a plurality of subcomponents, including a quantum repeater electrical circuitry 120, a quantum repeater transceiver 122, a quantum repeater teleporter 124 and a quantum repeater electrical memory 126. The quantum repeater electrical circuitry 120 is configured to manage the internal operations of the repeater. The quantum repeater transceiver 122 is configured for receiving and transmitting quantum information. The quantum repeater teleporter 124 is configured to facilitate the teleportation of the quantum message to the next node or the quantum receiver 138. The quantum repeater electrical memory 126. The quantum repeater electrical memory 126 stores program instructions required for the operation of the quantum repeater computing unit 118, to execute tasks, such as measuring a first hop relaxation time T₁₍ᵢ₎¹, estimating a second hop relaxation time T₁₍ᵢ₎², and calculating a minimum composite relaxation time T₁₍ᵢ₎.

The quantum repeater teleporter 124 within the quantum repeater 114 is configured to transmit the message to the quantum receiver 138 (R_{Q}) during the second hop by establishing an entanglement between at least one repeater memory qubit 116 and at least one receiver memory qubit 140 within the quantum receiver 138. The quantum repeater 114 is configured to teleport the message to the quantum receiver 138 over the TVAD quantum channel having a lowest quantum hashing outage probability.

The quantum source computing unit 130 is operatively connected within the quantum source node 110 and includes quantum source electrical circuitry 132, a quantum source transceiver 134, and a quantum source electrical memory 136 having quantum source program instructions. The quantum source computing unit 130 is configured to execute the quantum source program instructions to receive the minimum composite relaxation time T₁₍ᵢ₎ from each quantum repeater 114, select a quantum repeater with the largest composite relaxation time T_{1(best)}, and transmit a control signal to the selected quantum repeater with the largest composite relaxation time T_{1(best)} to forward the message to the quantum repeater R_{Q} during the second hop. The control signal is an instruction signal to the selected quantum repeater to direct the selected quantum repeater to communicate the quantum message to the quantum repeater R_{Q} during the second hop of the communication process.

The quantum receiver 138 is configured with at least one receiver memory qubit 140, to receive and store the quantum message after it has been transmitted by the selected quantum repeater 114 during the second hop. The quantum information is delivered and preserved at the final destination by the quantum receiver 138.

The system 100B is configured to estimate the second hop relaxation time T₁₍ᵢ₎² for transmitting the message from the quantum repeater i 114 to the quantum receiver 138.

Additionally, the system 110B includes an error correction unit 127 located in each quantum repeater 114, configured to estimate quantum hashing outage probability for each TVAD quantum channel, thereby ensuring that the transmission occurs over a most favorable link. In one exemplary implementation, each TVAD quantum channel is considered to be a time-varying amplitude damping Pauli twirl approximated (TVADPTA) channel. The error correction unit 127 of each quantum repeater i is further configured to estimate a quantum hashing outage probability of each TVADPTA channel.

The system 100B is further configured to calculate a minimum composite relaxation time T₁₍ᵢ₎, where T₁₍ᵢ₎ is given by T₁₍ᵢ₎=min(T₁₍ᵢ₎¹, T₁₍ᵢ₎²). The error correction unit 127 of each quantum repeater i is further configured to estimate the second hop relaxation time T₁₍ᵢ₎² by calculating a quantum hashing outage probability for each of the TVAD channels.

In the system 100B, each TVAD quantum channel is either a TVADPTA channel or a time-varying amplitude damping clifford twirl approximated (TVADCTA) channel. The quantum repeaters 114 are configured to estimate the quantum hashing outage probability of each channel type, enhancing the reliability of quantum communication in the presence of noise and other channel impairments.

The quantum source node 110 is further configured to transmit a control signal to each non-selected quantum repeater 114, instructing to each non-selected quantum repeater 114 to enter a sleep mode during the second hop, thereby conserving energy and managing system performance.

The system 100A and the system 100B, described with reference to FIG. 1A and FIG. 1B, respectively, comprises a dual-hop quantum network, which includes the quantum source node 110 or sender 102 S, K quantum repeaters 114 {Rᵢ, i=1, . . . , K}, and the quantum receiver 138 or destination D, as illustrated in FIG. 1B. Selection of the TVAD channels is directed towards the asymptotical limits, which serves as a model for wireline noisy time-varying quantum channels, such as fiber-optic channels and internet communications. A first plurality of TVAD channels is configured to connect the quantum source node 110 with the plurality of quantum repeaters 114. A second plurality of TVAD channels is configured to connect the plurality of quantum repeaters 114 with the quantum receiver 138.

The model considers the impact of relaxation time T₁ on the decoherence effects experienced by superconducting qubits. An experimental analysis demonstrated that T₁(t,w) can be modeled as a wide-sense stationary (WSS) random process characterized by a mean μ_{T1}, a standard deviation σ_{T1}, along with a stochastic coherence time T_{c}, which spans an order of minutes. Given that quantum algorithms have processing times and error correction rounds t_{algo} on the order of microseconds, where t_{algo}<<T_{c}, it is reasonable to assume that process remains constant during the execution of the algorithm. In other words, T₁(t,w) can be modeled as a random variable, and owing to the fact that the process is WSS, and represented as T₁(w)=T₁(t,w)|ₜ₌₀, ∀t∈[0,T], T<<T_{c}.

According to the experimental results, the random variable T₁(w) can be modeled using a Gaussian distribution

$$N ( {μ}_{{T}_{1}} , {σ}_{{T}_{1}}^{2} ) ,$$

where μ_{T}_{₁} is the mean of T₁ and

$${σ}_{{T}_{1}}^{2}$$

represents its variance. However, given that any realization of T₁(w) is to be positive, T₁ is modeled as a truncated Gaussian random variable within the region [0,∞]. Therefore, the probability density function (PDF) of T₁ is given by the following expression.

$${f}_{{T}_{1}} ( {t}_{1} ) = \{ \begin{matrix}\frac{1}{\sqrt{2 π} {σ}_{{T}_{1}}} \frac{{e}^{- \frac{{( {t}_{1} - {μ}_{{T}_{1}} )}^{2}}{2 {σ}_{{T}_{1}}^{2}}}}{1 - Q ( \frac{{μ}_{{T}_{1}}}{{σ}_{{T}_{1}}} )} , & if {t}_{1} \geq 0 \\ 0 , & otherwise\end{matrix} , \qquad ( 1 )$$

where Q(.) is the Q-function defined by

$$Q ( . ) = \frac{1}{\sqrt{2 π}} {\int }_{x}^{∞} {e}^{- \frac{{x}^{2}}{2}} dx .$$

The quantum communication network under consideration operates as a dual-hop network, wherein the quantum repeater (QR) 114 is utilized to relay the source signal to the quantum receiver 138. The quantum repeater 114 exhibiting the highest relaxation time T₁ is selected from among all available repeaters to execute this task. The source is configured with its specific code rate Rₐ, while each repeater may forward the message at its respective code rate {Rᵢ, i=1, . . . , K}. Additionally, each repeater, depending on its channel characteristics, will possess its unique relaxation time

$$\{ {T}_{1 ( i )}^{( j )} , i = 1 , … , K \} ,$$

where j is for hop number (j=1,2).

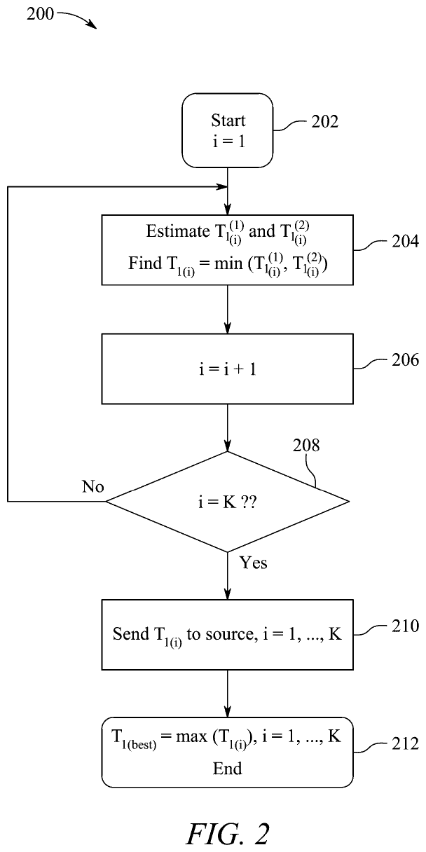

FIG. 2 illustrates a flowchart 200 of a method implemented for performing dual-hop quantum communication in a quantum network. The method is implemented using the system 100B, as described in reference to FIG. 1B. The flowchart 200 describes the method for selecting the quantum repeater to transmitting a message from the quantum source node to the destination through a series of quantum repeaters.

At step 202, the system 100B initiates with a counter set to i=1. Initiating the counter includes evaluating each quantum repeater in the network, where i denotes the index of the quantum repeater being evaluated.

At step 204, for the quantum repeater i, the system 100B estimates the first hop relaxation time T₁₍ᵢ₎¹ and the second hop relaxation time T₁₍ᵢ₎². These relaxation times are used for assessing an ability of the quantum repeater 114 to maintain qubit coherence during the quantum communication process. Following the estimation of these times, the system calculates the minimum composite relaxation time T₁₍ᵢ₎ for the repeater, where T₁₍ᵢ₎ is given by T₁₍ᵢ₎=min (T₁₍ᵢ₎¹, T₁₍ᵢ₎²). The composite relaxation time represents an overall readiness of the quantum repeater 114 to participate in the dual-hop communication.

At step 206, where the counter i is incremented by 1 (i=i+1), the system 100B is advanced to evaluate the next quantum repeater 114 in the network.

At step 208, the system checks whether the counter i has reached a total number of quantum repeaters, denoted as K. If i is less than K, the system returns to step 204 to repeat the estimation and calculation process for the next quantum repeater. If i=K, meaning all quantum repeaters have been evaluated, the process moves to the next step.

At step 210, after all quantum repeaters have been evaluated, each quantum repeater transmits its calculated minimum composite relaxation time T₁₍ᵢ₎ to the quantum source node. The transmission allows the quantum source node to gather all the necessary data to make an informed selection.

At step 212, the quantum source node determines the largest composite relaxation time T_{1(best)} among the K quantum repeaters, where T_{1(best)} is given by T_{1(best)}=max(T₁₍ᵢ₎) for i=1, . . . , K. The quantum repeater with the largest T_{1(best)} is selected to forward the message to the destination (the quantum receiver 138) during the second hop of communication, ensuring the most reliable transmission path is used.

A repeater selection methodology provided is distinctive as it integrates the temporal variations in relaxation time T₁ within its decision-making framework. Literature has demonstrated that T₁ exhibits characteristics of a random variable, fluctuating over time. Therefore, in situations involving multiple nodes where selection or scheduling decisions are required, it would be advantageous to incorporate the state of their channels, as reflected by T₁, into the selection criteria to enhance overall efficiency.

Utilizing an opportunistic repeater scheduling method, the quantum repeater with the highest relaxation time T₁ is selected to transmit the source message to the quantum receiver 128 during a second communication phase. The selection strategy ensures that data transmission is confined to the most favorable link, characterized by desirable channel conditions in terms of relaxation time T₁. It is noted that first-hop channels of each repeater

$$\{ {T}_{1 ( i )}^{( 1 )} , i = 1 , … , K \}$$

and second-hop channels

$$\{ {T}_{1 ( i )}^{( 2 )} , i = 1 , … , K \}$$

each have K relaxation times. For each repeater, a composite relaxation time is computed by taking the minimum among these values, denoted as

$${T}_{1 ( i )} = min ( {T}_{1 ( i )}^{( 1 )} , {T}_{1 ( i )}^{( 2 )} , i = 1 , … , K ) .$$

The quantum repeater possessing the maximum composite relaxation time T_{1(best)}=max{T₁₍ᵢ₎, 1=1, . . . , K} is subsequently selected to relay the source message to the destination. As a result, an increased number of quantum repeaters enhances the likelihood of selecting repeaters with higher relaxation times, thereby positively influencing the overall system performance concerning

$${P}_{out}^{Q} .$$

The method effectively reflects the quality of channels of individual nodes, where higher values of T₁ indicate superior channel quality, whereas lower values suggest suboptimal channel conditions.

The repeater selection strategy, implemented by the system 100B of FIG. 1B and further described with reference to FIG. 2, is predicated on an ability to measure the TVAD quantum channel relaxation time of both the source and the repeaters, a capability that can be realized using algorithms. As depicted in the flowchart of FIG. 2, during the initial communication phase, each repeater evaluates or measures its relaxation time on the first hop, denoted as T₁₍ᵢ₎ (1), i=1, . . . , K. Assuming that the realization of T₁ remains consistent throughout a block of quantum code, this relaxation time estimation can be performed at the commencement of each code block. While fluctuations in T₁ are uncorrelated from block to block, the fluctuation exhibits perfect correlation at the qubit level within the same block.

In the second communication phase, each quantum repeater estimates its relaxation time for the second hop, denoted as T₁₍ᵢ₎ (2), i=1, . . . , K. Upon completing the estimation of their relaxation times, denoted as T₁₍ᵢ₎, i=1, . . . , K, the quantum repeaters transmit the information to the source through, for example, a flag or pilot signals. The quantum source node 110 selects the quantum repeater with the highest T₁₍ᵢ₎ to forward its message to the destination (the quantum receiver 138) during the second communication phase. Once the quantum repeater has been selected, the quantum source node 110 communicates with the other quantum repeaters, instructing them to switch to sleep mode during the subsequent communication phase. It is also pertinent to note that alternative quantum repeater selection schemes exist, wherein a central unit manages all communications. It is emphasized that the quantum repeaters employed in this quantum network are of the third-generation type (although they can be of lower or higher generation types), configured to correct both loss and operational errors in the source message prior to the message transmission to the quantum receiver 138.

In examples, the information regarding T₁ for all nodes can be communicated to a central unit responsible for the scheduling process in a centralized manner. Additionally, the collection of information about T₁ and the repeater selection process occurs during a training mode before the actual data transmission between the quantum source node 110 and the quantum receiver 128. This exchange of information can be facilitated through either quantum channels or classical channels. The physical architecture of the third-generation QR primarily encompasses the following stages, controlled NOT gates, a memory, an encoder, a quantum error correction stage, and a relay.

In aspects, quantum capacity represents a maximum rate at which quantum information can be reliably communicated and corrected over multiple independent uses of a noisy quantum channel. In essence, quantum capacity establishes a quantum rate limit R_{Q}, below which reliable quantum communication or correction is asymptotically achievable with an infinitesimal error rate. The quantum channel capacity can also be defined as the maximum achievable rate by quantum error correction that ensures the transmitted, stored, or processed quantum information remains error-free. The quantum channel capacity C_{Q} is dependent on a channel noise parameter γ. The transmission code rate R_{Q} is dependent on a noise limit given by γₗ(R_{Q}), wherein the

$${P}_{out}^{Q}$$

is low when the noise limit is high. The first plurality of TVAD quantum channels each have a different transmission code rate R¹_{Qi} for i=1, . . . , K. The second plurality of time varying amplitude damping channels each have a different transmission code rate R²_{Qi} for i=1, . . . , K.

The definition of quantum capacity C_{Q}(N) parallels its classical counterpart, representing the supremum of all achievable quantum rates for a noisy channel N. While there is no closed-form analytical expression for the quantum capacity of general channels, the amplitude damping (AD) channel offers either a closed-form expression or bounds for its Lloyd-Shor-Devetak (LSD) capacity, a theorem that relates quantum channel capacity to a regularized coherent information of the channel.

The quantum capacity of a static AD channel (where T₁ is constant) with damping parameter γ∈[0, 1] is given by:

$${C}_{Q} ( γ ) = max \{ {h}_{2} ( ( 1 - γ ) p ) - {h}_{2} ( γ p ) \} , p ∈ [ 0 , 1 ] \qquad ( 2 )$$

where p denotes the probability, and h₂(.) represents the Shannon or binary entropy. Notably, the capacity in equation (2) vanishes whenever γ>½, attributable to the anti-degradability of AD channels.

The

$${P}_{out}^{Q}$$

for both independent non-identically distributed (i.ni.d.) and independent identically distributed (i.i.d.) repeater channels is derived. Analogous to the definition of outage probability in classical block fading scenarios, the

$${P}_{out}^{Q}$$

event occurs when the quantum channel capacity C_{Q} (measured in qubits per channel use) falls below the quantum coding rate R_{Q} (measured in qubits per channel use). In such a scenario, the channel is deemed to be in outage, and the quantum bit error rate will not diminish asymptotically with the block length, regardless of the selected quantum error correction code (QECC). Consequently, the

$${P}_{out}^{Q}$$

can be mathematically expressed as:

$${P}_{out}^{Q} {R}_{Q} = {P}_{r} [ w ∈ Ω : {C}_{Q} ( γ ( w ) ) < {R}_{Q} ] \qquad ( 3 )$$

The event described in equation (3) is also equivalent to two other events. First, the event that the channel is noisier than a permissible noise limit [w∈Ω:γ(w)>γₗ(R_{Q})]. Second, the event that the relaxation time T₁ is lower than an allowable time limit [w∈Ω:T₁(w)<T₁ₗ(R_{Q},γ)], T₁ₗ(R_{Q},γ)=μ_{T1} ln(1−γ)/ln(1−γₗ(R_{Q})). The first limit is directly relevant to the transmission code rate R_{Q}, while the second limit is pertinent to both R and the channel noise or damping parameter γ. The probability of last event is simply the cumulative distribution function (CDF) of T₁ evaluated at T₁ₗ(R_{Q},γ), and it is given by:

$${P}_{out}^{Q} ( {R}_{Q} ) = {F}_{{T}_{1}} ( {T}_{1 l} ( {R}_{Q} , γ ) ) = 1 - \frac{Q ( \frac{1}{ε} [ \frac{ln ( 1 - γ )}{ln ( 1 - {γ}_{l} ( {R}_{Q} ) )} - 1 ] )}{1 - Q ( \frac{1}{ε} )} , \qquad ( 4 )$$

where

$$ε = \frac{{σ}_{{T}_{1}}}{{μ}_{{T}_{1}}}$$

denotes the coefficient of variation of the random variable T₁, where σ_{T1} and μ_{T1} are the standard deviation and mean of the random variable, respectively, and γₗ(R_{Q}) is the noise limit. To ensure that the channel supports the transmission rate, noise in the quantum channel should be kept below the threshold, i.e., the channel damping parameter γ should be less than γₗ(R_{Q}). Consequently, a larger noise threshold corresponds to a lower

$${P}_{out}^{Q}$$

and improved performance.

The result in equation (4) can also be expressed as:

$${P}_{out}^{Q} ( {R}_{Q} ) = 1 - \frac{\frac{1}{2} erfc ( \frac{1}{ε \sqrt{2}} [ \frac{ln ( 1 - γ )}{ln ( 1 - {γ}_{l} ( {R}_{Q} ) )} - 1 ] )}{1 - \frac{1}{2} erfc ( \frac{1}{ε \sqrt{2}} )} , \qquad ( 5 )$$

where erfc(x) is the complementary error function defined by

$$\frac{2}{\sqrt{π}} {\int }_{x}^{∞} {e}^{- {x}^{2}} dx .$$

The

$${P}_{out}^{Q}$$

for the considered dual-hop quantum network with multiple repeaters is derived.

In the scenario involving independent non-identically distributed (i.ni.d.) repeater channels, it is considered that the source transmits messages to repeaters at varying code rates {Rₛᵢ, i=1, . . . , K} and that the repeaters have different code rates {Rᵢ, i=1, . . . , K}. It is also considered that the repeaters possess different coefficients of variation for their channel relaxation times on the first hop

$$\{ {T}_{1 ( i )}^{( 1 )} , i = 1 , … , K \} ,$$

given by

$$\{ {ε}_{i}^{( 1 )} , i = 1 , … , K \} ,$$

and different coefficients of variation for relaxation times of their channels on the second hop

$$\{ {T}_{1 ( i )}^{( 2 )} , i = 1 , … , K \} ,$$

given by

$$\{ {ε}_{i}^{( 2 )} , i = 1 , … , K \} .$$

The repeater composite relaxation time is defined as

$${T}_{1 ( i )} = min ( {T}_{1 ( i )}^{( 1 )} , {T}_{1 ( i )}^{( 2 )} , i = 1 , … , K ) .$$

Under the repeater selection strategy, the repeater with the largest T₁, denoted as T_{1(best)}=max {T₁₍ᵢ₎, 1=1, . . . , K}, is selected to forward the source message to the destination during the second communication phase.

To facilitate communication between the source and destination via repeaters, a training or guard period is first employed to determine the relaxation times of the repeaters on both the first and second hops. During the first communication phase, repeaters with relaxation times greater than an allowable time limit, denoted as

$${T}_{1 ( k )}^{( 1 )} \geq {T}_{1 l} ( {R}_{Q} , γ ) ,$$

are classified as successful repeaters and included in a decoding set called B_{L}. This set comprises all the repeaters that successfully decoded the source message during the first communication phase and is defined as:

$${B}_{L} {=}^{Δ} \{ k ∈ {S}_{r} : {T}_{1 ( k )}^{( 1 )} ( w ) \geq {T}_{1 l} ( {R}_{Q} , γ ) \} , \qquad ( 6 )$$

where Sᵣ is the set of all repeaters and T₁ₗ(R_{Q},γ) denotes an affordable time limit.

The probability of the decoding set defined in (6) can be written as:

$${P}_{r} [ {B}_{L} ] = {\prod }_{n ∈ {B}_{L}}^{L} {P}_{r} [ {T}_{1 ( n )}^{( 1 )} ( w ) \geq {T}_{1 l}^{L} ( {R}_{Q} , γ ) ] {\prod }_{m ∉ {B}_{L}}^{L} {P}_{r} [ {T}_{1 ( m )}^{( 1 )} ( w ) < {T}_{1 l}^{L} ( {R}_{Q} , γ ) ] , \qquad ( 7 )$$

where the terms in the first product represent complementary CDFs (CCDFs), while the terms in the second product represent CDFs.

Using the total probability theorem, the

$${P}_{out}^{Q}$$

of the system can be achieved by averaging over all the possible decoding sets as follows:

$${P}_{o u t}^{Q} ( {R}_{Q} ) = {\sum }_{L = 0}^{K} {\sum }_{B L} {P}_{r} [ {T}_{1 ( b e s t )} ( w ) < {T}_{1 l} ( {R}_{Q} , γ ) \vert {B}_{L} ] {P}_{r} [ {B}_{L} ] , \qquad ( 8 )$$

where T_{1(best)}(w) is the relaxation time at the destination, which according to opportunistic repeater selection represents the best second hop relaxation time of all repeaters in the decoding set B_{L}. The internal summation is taken over all of

$$( \begin{matrix}K \\ L\end{matrix} )$$

possible subsets of size L from the set with K repeaters.

To evaluate equation (8), expressions must first be derived for Pᵣ[T_{1(best)}(w)<T₁ₗ(R_{Q},γ)|B_{L}] and Pᵣ[B_{L}]. In order to evaluate Pᵣ[B_{L}], the CDFs and CCDFs of the first hop quantum channels are obtained. The CDF of the quantum channel between the quantum source node 110 and the i^{th} repeater is given by:

$${P}_{r} [ {T}_{1 ( i )}^{( 1 )} ( w ) < {T}_{1 l} ( {R}_{si} , γ ) ] = 1 - \frac{\frac{1}{2} erfc ( \frac{1}{{ε}_{i}^{( 1 )} \sqrt{2}} [ \frac{ln ( 1 - γ )}{ln ( 1 - {γ}_{l} ( {R}_{si} ) )} - 1 ] )}{1 - \frac{1}{2} erfc ( \frac{1}{{ε}_{i}^{( 1 )} \sqrt{2}} )} , \qquad ( 9 )$$

where γₗ(Rᵢ) denotes the noise limit. Utilizing equation (9), the CCDF can also be obtained. By substituting these quantities into equation (7), the distribution of the decoding set can be determined.

Under opportunistic repeater selection, the CDF Pᵣ[T_{1(best)}(w)<T₁ₗ(R_{Q},γ)|B_{L}] represents the CDF of the second hop relaxation time of the best repeater among all repeaters in the decoding set B_{L}, and is given by:

$${P}_{r} [ {T}_{1 ( b e s t )} ( w ) < {T}_{1 l} ( {R}_{Q} , γ ) \vert {B}_{L} ] = {\prod }_{i = 1}^{L} {P}_{r} [ {T}_{1 ( i )}^{( 2 )} ( w ) < {T}_{1 l} ( {R}_{i} , γ ) ] , \qquad ( 10 )$$

where

$${P}_{r} [ {T}_{1 ( i )}^{( 2 )} ( w ) < {T}_{1 l} ( {R}_{i} , γ ) ]$$

is the CDF of the second hop relaxation time of the repeater. The CDF has a similar form to that in equation (9), but with the parameters adjusted for the second hop. By substituting equations (9) and (10) into equation (8), the

$${P}_{out}^{Q}$$

for the i.ni.d. case of the considered network, associated with the damping parameter γ∈[0,1−e⁻¹], can be determined.

The analysis of independent identically distributed (i.i.d.) repeaters' channels considers the scenario where the source transmits to repeaters at a uniform rate, denoted as {Rₛᵢ=Rₐ, i=1, . . . , K}, and where the repeaters maintain a consistent code rate {Rᵢ=R_{b}, i=1, . . . , K}. It is assumed that the repeaters exhibit a uniform coefficient of variation for relaxation times of the respective channel on the first hop,

$$\{ {T}_{1 ( i )}^{( 1 )} , i = 1 , … , K \} ,$$

denoted by

$$\{ {ε}_{i}^{( 1 )} = {ϵ}_{a} , i = 1 , … , K \} ,$$

as well as a uniform coefficient of variation for relaxation times of their channels on the second hop,

$$\{ \{ {T}_{1 ( i )}^{( 2 )} , i = 1 , … , K \} ,$$

represented by

$$\{ {ε}_{i}^{( 2 )} = {ϵ}_{b} , i = 1 , … , K \} .$$

In this scenario, the CDF

$${P}_{r} [ {T}_{1 ( b e s t )}^{1} ( w ) < {T}_{1 l} ( {R}_{Q} , γ ) \vert {B}_{L} ]$$

is expressed as:

$${P}_{r} [ {T}_{1 ( b e s t )}^{1} ( w ) < {T}_{1 l} ( {R}_{Q} , γ ) \vert {B}_{L} ] = {[ {P}_{r} [ {T}_{1 ( i )}^{( 2 )} ( w ) < {T}_{1 l} ( {R}_{b} , γ ) ] ]}^{K} . \qquad ( 11 )$$

Upon integrating equations (9) and (10) into equation (8), the quantum outage probability (QOP) for the i.i.d. case of the considered network, associated with the damping parameter γ∈[0,1−e⁻¹] can be derived.

In the context of hashing quantum outage probability (HQOP), the focus shifts to establishing the quantum hashing outage probability for time-varying amplitude damping Pauli twirl approximated (TVADPTA) and time-varying amplitude damping clifford twirl approximated (TVADCTA) channels for both independent non-identically distributed (i.ni.d.) and independent identically distributed (i.i.d.) repeaters channels. These two Pauli models hold significant relevance in the quantum computing domain, serving as fundamental representations of the simplest types of noise encountered in quantum devices.

In one aspect, each TVAD channel is the TVADPTA channel. The TVAD and TVADPTA models are effective in modeling TVAD channels when the number of qubits becomes large. In scenarios where implementing the TVAD channel model directly onto quantum devices becomes overly complex due to the high qubit count, an alternative approach involves utilizing approximate channel models through a technique in quantum information known as twirling. The technique enables the examination of the average impact of general quantum noise models by mapping them to more symmetric versions of themselves.

Although the TVADPTA and TVADCTA approximate channels, along with Pauli channels in general, do not possess closed-form expressions for their quantum capacity, a lower bound, which can be achieved using stabilizer codes, was introduced in the literature. The bound is known as the hashing bound, denoted by C_{H}, and is defined for Pauli channels by the probability mass function p=(p_{I}, pₓ, p_{y}, p_{z}). The hashing bound C_{H}(p) is given by:

$${C}_{H} ( p ) = 1 - {H}_{2} ( p ) , \qquad ( 12 )$$

where H₂(p)=−Σⱼpⱼ log₂(pj) represents the entropy in bits of a discrete random variable with a probability mass function defined by p. The parameters p=(p_{I}, pₓ, p_{y}, p_{z}) are functions of relaxation time of channel T₁ and are given for TVADPTA channels by:

$${p}_{I} ( γ ) = {( \frac{1 + \sqrt{1 - γ ( w )}}{2} )}^{2} , \qquad ( 13 )$$

$${p}_{x} ( γ ) = {p}_{y} ( γ ) = \frac{γ ( w )}{4} , \qquad ( 14 )$$

$${p}_{z} ( γ ) = {( \frac{1 - \sqrt{1 - γ ( w )}}{2} )}^{2} , \qquad ( 15 )$$

where Σ_{k∈{I,x,y,z}}pₖ(γ).

For TVADCTA channels, these parameters are defined similarly, with p_{I}(γ) as defined in equation (13), and

$${p}_{x} ( γ ) = {p}_{y} ( γ ) = {p}_{z} ( γ ) = \frac{1 - {p}_{I} ( γ )}{3} .$$

In alignment with the definition of

$${p}_{out}^{Q} ,$$

if the quantum hashing channel capacity C_{H}(p), or equivalently C_{H}(γ(w)) qubits per channel use, becomes lower than the quantum coding rate R_{Q} qubits per channel use, then a quantum hashing outage probability event occurs. Accordingly, the quantum hashing outage probability is defined as:

$${P}_{o u t}^{H} ( {R}_{Q} ) = {P}_{r} [ w ∈ Ω : {C}_{H} ( γ ( w ) ) < {R}_{Q} ] . \qquad ( 16 )$$

The hashing quantum outage probability in equation (18) serves as an upper bound on the

$${P}_{o u t}^{Q}$$

of TVADPTA and TVADCTA channels, which could be lower in practical scenarios.

Analogous to the

$${P}_{o u t}^{Q}$$

provided in equation (4), the quantum hashing outage probability can be shown to be expressed for twirled approximated channels by:

$${P}_{o u t}^{H} ( {R}_{Q} ) = 1 - \frac{Q ( \frac{1}{ε} [ \frac{ln ( 1 - γ )}{ln ( 1 - {γ}_{l}^{T} ( {R}_{Q} ) )} - 1 ] )}{1 - Q ( \frac{1}{ε} )} \qquad ( 17 )$$

The result in equation (17) can also be expressed in terms of the complementary error function as:

$${P}_{o u t}^{H} ( {R}_{Q} ) = 1 - \frac{\frac{1}{2} erfc ( \frac{1}{ε \sqrt{2}} [ \frac{ln ( 1 - γ )}{ln ( 1 - {γ}_{l}^{T} ( {R}_{Q} ) )} - 1 ] )}{1 - \frac{1}{2} erfc ( \frac{1}{ε \sqrt{2}} )} , \qquad ( 18 )$$

Compared to the

$${P}_{out}^{Q}$$

of TVAD channels, the outage probability in equation (20) is similar except for one term, which is the noise limit γₗ^{T}(R_{Q}). In the case of twirled approximated channels, the noise limit is calculated differently from that of normal TVAD channels. For the TVADPTA and TVADCTA channels, the noise limit is determined using the parameters (p_{I}, pₓ, p_{y}, p_{z}) defined previously, along with the entropy given in equation (14).

The subsequent sections of the present disclosure present the results of the quantum hashing outage probability for the considered dual-hop quantum network of multiple repeaters.

In channels of independent non-identically distributed (i.ni.d.) repeaters, following the aforementioned approach described for

$${P}_{out}^{Q}$$

and after replacing γₗ(R) by γₗ^{T}(R), the quantum hashing outage probability for the i.ni.d. case of the considered network associated with the damping parameter γ∈[0,1−e⁻¹] can be derived.

In channels of independent identically distributed (i.i.d.) repeaters, following the aforementioned approach described in for

$${P}_{out}^{Q}$$

and after replacing γₗ(R) by γₗ^{T}(R), the quantum hashing outage probability for the i.i.d. case of the considered network associated with the damping parameter γ∈[0,1−e⁻¹], can be derived.

Various system parameters and their effect on the system performance are considered in this section. The system includes number of repeaters K, coefficient of variation of T₁ for first hop

$$\{ {ε}_{i}^{( 1 )} , i = 1 , … , K \}$$

and second hop

$$\{ {ε}_{i}^{( 2 )} , i = 1 , … , K \} ,$$

quantum code rates of first hop {Rₛᵢ, i=1, . . . , K} and second hop {Rᵢ, i=1, . . . , K}, and channel damping parameter γ. As shown below and without loss of generality, it is assumed that

$${ε}_{i}^{( 1 )} = {ε}_{a} , {ε}_{i}^{( 2 )} = {ε}_{b} ,$$

and Rₛᵢ=Rₐ, Rᵢ=R_{b} for {i=1, . . . , K}.

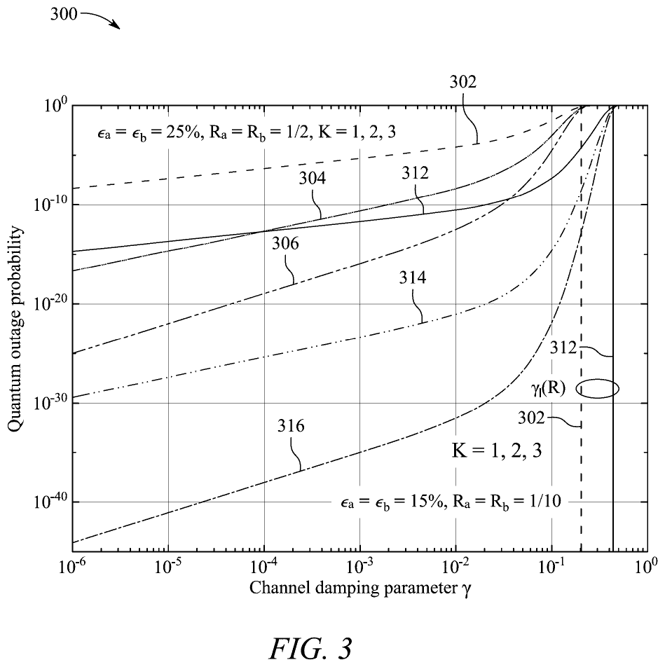

FIG. 3 is a graphical representation illustrating the

$${P}_{out}^{Q}$$

as a function of the channel damping parameter γ under various system conditions. Graph 300 presents two sets of curves, each representing different scenarios defined by specific values of the coefficient of variation ϵ and the code rates Rₐ and R_{b}.

Curves 302, 304, and 306 in the graph 300 correspond to the case where ϵₐ=ϵ_{b}=25% and Rₐ=R_{b}=½. The quantum outage probability

$${P}_{out}^{Q}$$

for K=1 repeater is represented by curve 302, while the

$${P}_{out}^{Q}$$

for K=2 repeaters is depicted by curve 304, and the

$${P}_{out}^{Q}$$

for K=3 repeaters is shown by curve 306. As observed from the curves, the

$${P}_{out}^{Q}$$

decreases as the number of repeaters K increases, indicating improved system performance with a greater number of repeaters.

Curves 312, 314, and 316 in the graph 300 illustrate the scenario where ϵₐ=ϵ_{b}=15% and Rₐ=R_{b}= 1/10. In this set, the

$${P}_{out}^{Q}$$

for K=1 repeater is represented by curve 308, for K=2 repeaters by curve 310, and for K=3 repeaters by curve 312. Similar to the first set, increasing the number of repeaters K leads to a reduction in the

$${P}_{out}^{Q} ,$$

further enhancing system reliability.

The graph 300 clearly demonstrates that lower coefficients of variation and code rates result in better performance, with the

$${P}_{out}^{Q}$$

being lower in the second set of curves compared to the first. The influence of the noise limit γl(R), which varies with the code rate, is also evident in

$${P}_{out}^{Q}$$

of the system, with higher noise limits contributing to a more robust system performance.

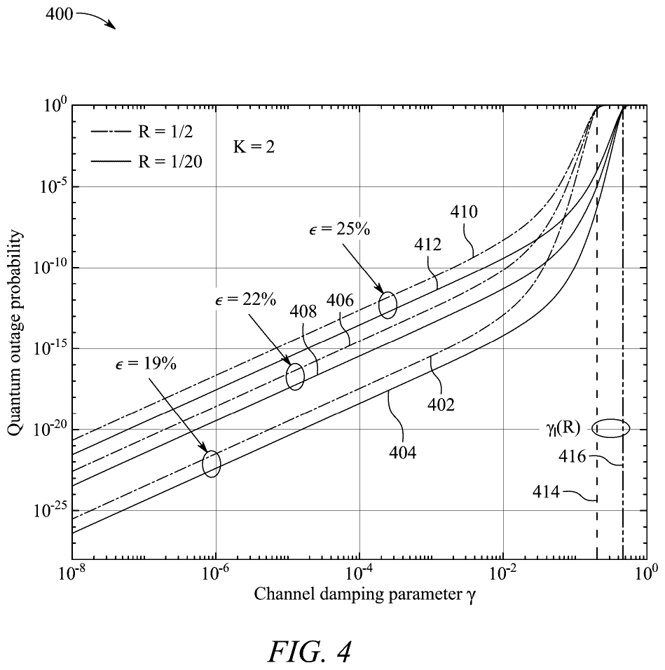

FIG. 4 is a graphical representation of a detailed analysis of the impact of the coefficients of variation ϵₐ and ϵ_{b} on the

$${P}_{out}^{Q} ,$$

along with the effects of different code rates. The graph 400 showcases several curves representing these relationships.

Curve 402 represents

$${P}_{out}^{Q}$$

when parameters are ϵ=19% and R=½, while curve 404 represents ϵ=19%, K=2, and R= 1/20. Curve 406 represents

$${P}_{out}^{Q}$$

when parameters are ϵ=22%, K=2, and R=½, while curve 408 represents ϵ=22%, K=2, and R= 1/20. Curve 410 represents

$${P}_{out}^{Q}$$

when parameters are ϵ=25% and R=½, while curve 412 represents ϵ=25% and R= 1/20. Curve 414 represents response for γₗ(R), when R=½. Curve 416 represents response for γₗ(R), when R= 1/20.

Graph 400 shows that as the coefficients of variation increase, the

$${P}_{out}^{Q}$$

also increases, indicating a higher susceptibility to outages under more variable channel conditions. Additionally, the graph 400 reveals that higher code rates result in an increased

$${P}_{out}^{Q} .$$

This trend suggests that systems with higher code rates require more stringent channel conditions to maintain reliable communication, making them more prone to quantum outages under less favorable conditions.

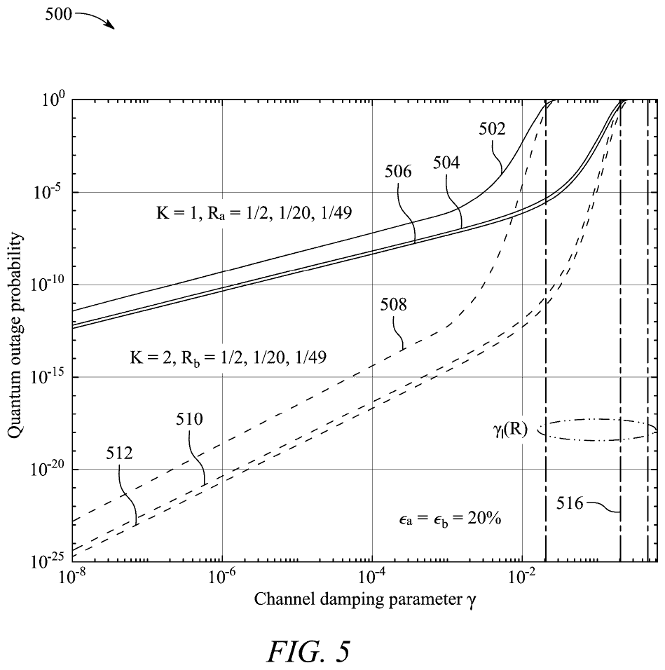

FIG. 5 is a graphical representation illustrating the

$${P}_{out}^{Q}$$

as a function of the channel damping parameter γ for various values of the number of quantum repeaters K, the source code rate Rₐ, and the repeater code rate R_{b}. Graph 500 presents the relationship between these parameters and the system performance under different conditions.

As shown in the graph 500, the

$${P}_{out}^{Q}$$

is plotted against the channel damping parameter γ, with multiple curves representing different values of K, Rₐ, and R_{b}. Curve 502 represents the response, where K=1, and Rₐ=½. Curve 504 represents the response, where K=1 and Rₐ= 1/20. Curve 506 represents the response, where K=1 and Rₐ= 1/49. Curve 508 represents the response, where K=2, and R_{b}=½. Curve 510 represents the response, where K=2 and R_{b}= 1/20. Curve 512 represents the response, where K=2 and R= 1/49.

From the graph 500, it is evident that as the value of K increases, the

$${P}_{out}^{Q}$$

decreases, indicating improved system performance. The improvement is attributed to the increased number of quantum repeaters, which enhances the likelihood of encountering repeaters with larger relaxation times, thereby reducing the outage probability. Additionally, the curves illustrate that lower code rates Rₐ and R_{b} also contribute to a lower quantum outage probability, further improving system performance.

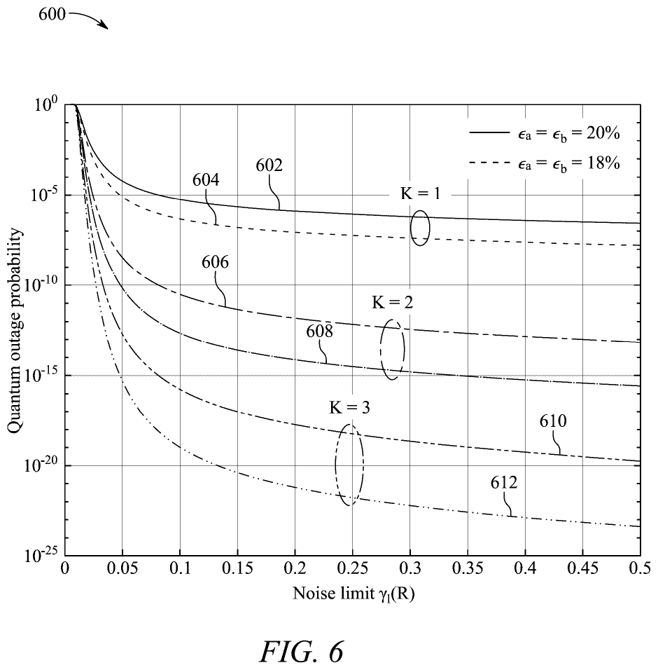

FIG. 6 presents the

$${P}_{out}^{Q}$$

as a function of the noise limit γl(R) for various values of the coefficient of variation ϵₐ and ϵ_{b}, and the number of quantum repeaters K. The graph describes the impact of these parameters on

$${P}_{out}^{Q}$$

the system.

Graph 600 shows that the

$${P}_{out}^{Q}$$

decreases as the noise limit γl(R) increases. When ϵₐ and ϵ_{b}=20% and K=1, curve 602 represents the

$${P}_{out}^{Q}$$

for the noise limit γl(R). When ϵₐ and ϵ_{b}=18% and K=1, curve 604 represents the

$${P}_{out}^{Q}$$

for the noise limit γl(R). When ϵₐ and ϵ_{b}=20% and K=2, curve 606 represents the

$${P}_{out}^{Q}$$

for the noise limit γl(R). When ϵₐ and ϵ_{b}=18% and K=2, curve 608 represents the

$${P}_{o u t}^{Q}$$

for the noise limit γl(R). When ϵₐ and ϵ_{b}=20% and K=3, curve 610 represents the

$${P}_{o u t}^{Q}$$

for the noise limit γl(R). When ϵₐ and ϵ_{b}=18% and K=3, curve 612 represents the

$${P}_{o u t}^{Q}$$

for the noise limit γl(R). The curves demonstrate that lower coefficients of variation lead to better performance, as the system becomes more resilient to noise fluctuations.

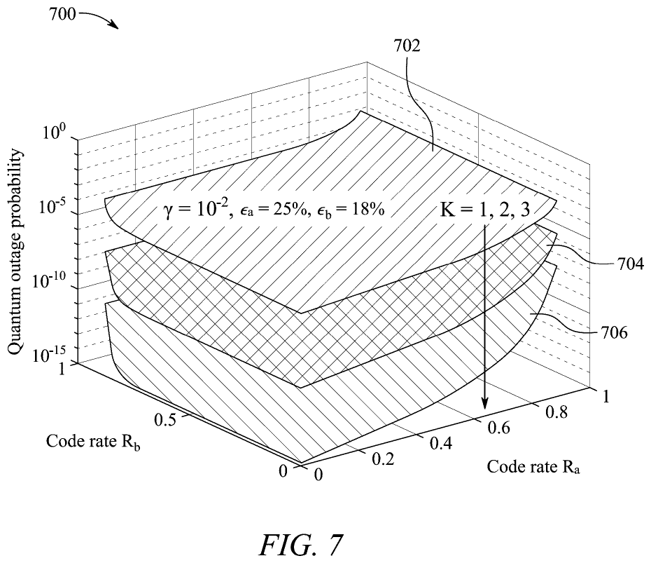

FIG. 7 is a three-dimensional graphical representation illustrating the

$${P}_{o u t}^{Q}$$

s a function of the code rate of the first hop (Rₐ) and the code rate of the second hop (R_{b}) for varying numbers of repeaters K. The plot provides insight into how different combinations of code rates and repeater counts influence the overall performance of the system. As depicted in the graph 700, the quantum outage probability decreases as the number of repeaters K increases, which is expected because additional repeaters enhance the probability of selecting a repeater with a superior relaxation time T₁, thereby improving the performance of the system.

In the graph, curve 702 represents the scenario where K=1, γ=10⁻², ϵₐ=25%, and ϵ_{b}=18% showing the highest outage probability across all combinations of Rₐ and R_{b}, due to the limited diversity in the system. Curve 704, where K=1, γ=10⁻², ϵₐ=25%, and ϵ_{b}=18%, demonstrates a noticeable improvement in performance, as indicated by the lower quantum outage probability compared to curve 702. Curve 706, where K=1, γ=10⁻², ϵₐ=25%, and ϵ_{b}=18%, shows the most significant reduction in quantum outage probability, particularly at lower values of Rₐ and R_{b}, emphasizing the advantage of having a greater number of repeaters in the system.

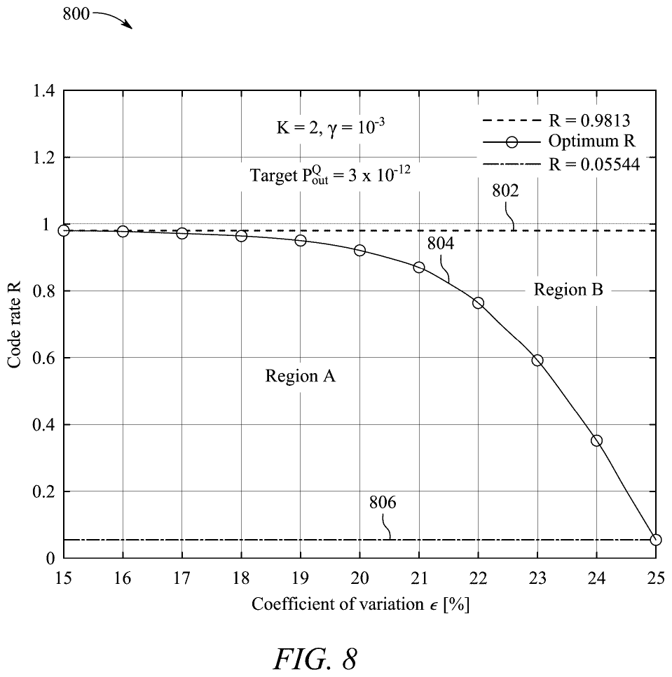

FIG. 8 presents a graphical analysis determining the code rates required to achieve a specific target quantum outage probability, set at 3×10⁻¹². The graph 800 showcases two primary regions, region A and region B. In region A, transmitting at the code results in a quantum outage probability lower than the target value, at the expense of reduced transmission rates. Conversely, region B includes code rates that exceed a desired rate, but this comes at the cost of surpassing the target quantum outage probability. Curve 802, represents the code rate R response, R=0.9812, having parameters at K=2, γ=10⁻³, and target

$${P}_{o u t}^{Q} = 3 \times {10}^{- 12} .$$

The curve 804 represents a scenario where the coefficient of variation is lower, leading to a more desirable performance, where R is at a desired level, having parameters at K=2, γ=10⁻³, and target

$${P}_{o u t}^{Q} = 3 \times {10}^{- 12} .$$

On the other hand, the curve 806 depicts a higher coefficient of variation, where R=0.05544, having parameters at K=2, γ=10⁻³, and target

$${P}_{o u t}^{Q} = 3 \times {10}^{- 12} ,$$

illustrating the necessity to employ lower code rates to maintain the desired outage performance.

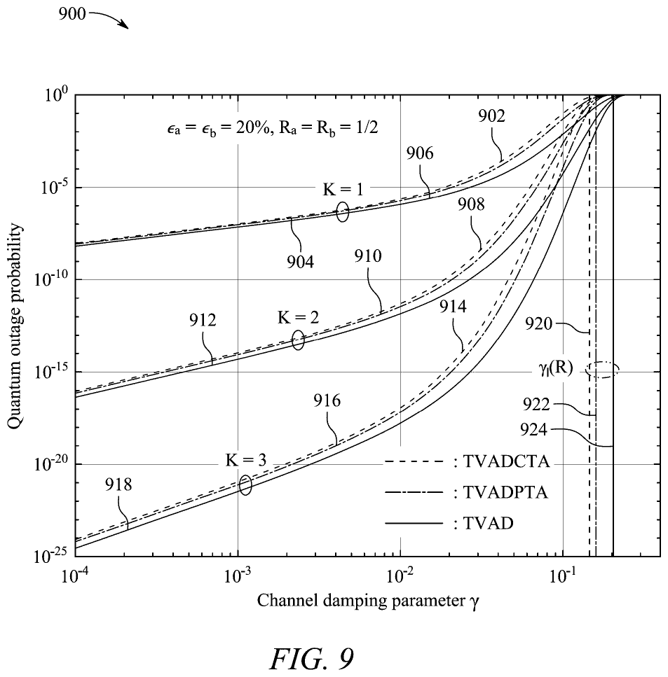

FIG. 9 is a graphical representation illustrating the quantum outage probability

$${P}_{o u t}^{Q}$$

as a function of the channel damping parameter 7 for three different types of quantum channels: TVAD, TVADPTA, and TVADCTA. The curves in FIG. 9 depict how the quantum outage probability varies under these channel models with different numbers of quantum repeaters K. The first set of curves corresponds to K=1, the second set to K=2, and the third set to K=3.

As shown in FIG. 9, the

$${P}_{o u t}^{Q}$$

decreases as the number of quantum repeaters K increases, regardless of the quantum channel model used. The pattern is evident in all three channel types, TVAD, TVADCTA, and TVADPTA, indicating that increasing the number of quantum repeaters enhances performance of the system by reducing the probability of a quantum outage. Curve 902 represents

$${P}_{o u t}^{Q}$$

for TVADCTA channel with parameters, ϵₐ=ϵ_{b}=20%, Rₐ=R_{b}=½, and K=1. Curve 904 represents

$${P}_{o u t}^{Q}$$

for TVADPTA channel with parameters, ϵₐ=ϵ_{b}=20%, Rₐ=R_{b}=½, and K=1. Curve 906 represents

$${P}_{o u t}^{Q}$$

for TVAD channel with parameters, ϵₐ=ϵ_{b}=20%, Rₐ=R_{b}=½, and K=1. Curve 908 represents

$${P}_{o u t}^{Q}$$

for TVADCTA channel with parameters, ϵₐ=ϵ_{b}=20%, Rₐ=R_{b}=½, and K=2. Curve 910 represents

$${P}_{o u t}^{Q}$$

for TVADPTA channel with parameters, ϵₐ=ϵ_{b}=20%, Rₐ=R_{b}=½, and K=2. Curve 912 represents

$${P}_{o u t}^{Q}$$

for TVAD channel with parameters, ϵa=ϵb=20%, Rₐ=R_{b}=½, and K=2. Curve 914 represents

$${P}_{o u t}^{Q}$$

for TVADCTA channel with parameters, ϵa=ϵb=20%, Rₐ=R_{b}=½, and K=3. Curve 916 represents

$${P}_{o u t}^{Q}$$

for TVADPTA channel with parameters, ϵa=ϵb=20%, Rₐ=R_{b}=½, and K=3. Curve 918 represents

$${P}_{o u t}^{Q}$$

for TVAD channel with parameters, ϵa=ϵb=20%, Rₐ=R_{b}=½, and K=3. Curve 920 represents

$${P}_{o u t}^{Q}$$

for TVADCTA channel with parameters γₗ=(R). Curve 922 represents

$${P}_{o u t}^{Q}$$

for TVADPTA channel with parameters γₗ=(R). Curve 924 represents

$${P}_{o u t}^{Q}$$

for TVAD channel with parameters γₗ=(R).

Specifically, the

$${P}_{o u t}^{Q}$$

for the TVAD channel is lower than that for the TVADPTA and TVADCTA channels. This difference arises because the noise limits for these channels are calculated differently, leading to distinct performances. The TVADCTA channel, represented by the highest curves, exhibits the worst performance among the three due to its smallest noise limit γₗTVADCTA.

In an exemplary embodiment, a method for dual-hop quantum communication includes transmitting during a first hop, by a quantum source node teleporter, a message to a plurality K of quantum repeaters over a plurality of time varying amplitude damping channels, where the message includes at least one superconducting qubit, receiving, by each quantum repeater i, where i=1, . . . , K, the message from the quantum source node, and measuring, by each quantum repeater i, a first hop relaxation time T₁₍ᵢ₎¹. The method further includes estimating, by each quantum repeater i, a second hop relaxation time T₁₍ᵢ₎² for transmitting the message from the quantum repeater i to a quantum repeater R_{Q}, calculating, by each quantum repeater i, a minimum composite relaxation time T₁₍ᵢ₎, where T₁₍ᵢ₎ is given by T₁₍ᵢ₎=min(T₁₍ᵢ₎¹, T₁₍ᵢ₎²), transmitting, by each quantum repeater i, the minimum composite relaxation time T₁₍ᵢ₎ to the quantum source node, and determining, by the quantum source node, the largest composite relaxation time T_{1(best)} of the K quantum repeaters, where T_{1(best)} is given by T_{1(best)}=max(T₁₍ᵢ₎) for i=1, . . . , K. The method further includes selecting, by the quantum source node, the quantum repeater with the largest composite relaxation time T_{1(best)}, transmitting, by the quantum source node, a control signal to the selected quantum repeater with the largest composite relaxation time T_{1(best)} to forward the message to the quantum repeater R_{Q} during the second hop, and transmitting, by the selected quantum repeater, the message to the quantum repeater R_{Q} during the second hop.

In some embodiments, the method includes transmitting, by the quantum source node, a control signal to each non-selected quantum repeater to sleep during the second hop.

In some embodiments, estimating the second hop relaxation time T₁₍ᵢ₎² comprises estimating, by an error correction unit located in each quantum repeater i, a quantum outage probability

$${P}_{o u t}^{Q}$$

based on a quantum channel capacity C_{Q} and a transmission code rate R_{Q} of qubits per channel.

In some embodiments, the quantum channel capacity C_{Q} is dependent on a channel noise parameter γ, and the transmission code rate R_{Q} is dependent on a noise limit given by γₗ(R_{Q}), where the quantum outage probability

$${P}_{o u t}^{Q}$$

is low when the noise limit is high.

In some embodiments, estimating the second hop relaxation time T₁₍ᵢ₎² comprises determining, by each quantum repeater i, a quantum hashing outage probability for each of the time varying amplitude damping channels.

In some embodiments, each time-varying amplitude damping channel is a time-varying amplitude damping Pauli twirl approximated channel, and estimating, by each quantum repeater i, the quantum hashing outage probability of each time-varying amplitude damping Pauli twirl approximated channel.

In some embodiments, each time-varying amplitude damping channel is a time-varying amplitude damping Clifford twirl approximated channel, and estimating, by each quantum repeater i, the quantum hashing outage probability of each time-varying amplitude damping Clifford twirl approximated channel.

In some embodiments, the method includes transmitting, by the selected quantum repeater, the message to the quantum receiver over the amplitude damping quantum channel having the lowest quantum hashing outage probability.

In some embodiments, the method includes transmitting, during the first hop, by the quantum source node teleporter, the message to the plurality K of quantum repeaters over the plurality of time varying amplitude damping channels by establishing entanglement between the at least one superconducting qubit and the at least one repeater memory qubit.

In some embodiments, the method includes transmitting, by a repeater transporter of the selected quantum repeater, the message to the quantum repeater R_{Q} during the second hop by establishing entanglement between the at least one repeater memory qubit and at least one receiver memory qubit.

In another exemplary embodiment, a system for dual-hop quantum communication is described. The system includes a quantum source node, a source encoder operatively connected within the quantum source node, where the encoder is configured to encode a message including at least one superconducting qubit, and a plurality K of quantum repeaters, where each quantum repeater i, where i=1, . . . , K, includes at least one repeater memory qubit and a quantum repeater computing unit. The system further includes a quantum source node teleporter operatively connected within the quantum source node, where the quantum source node teleporter is configured to transmit the message by establishing entanglement between the at least one superconducting qubit and the at least one repeater memory qubit, and a receiver configured with at least one receiver memory qubit.

The quantum repeater computing unit of each quantum repeater i includes a quantum repeater electrical circuitry, a quantum repeater transceiver, a quantum repeater teleporter, a quantum repeater electrical memory having quantum repeater program instructions and at least one quantum repeater processor configured to execute the quantum repeater program instructions to measure a first hop relaxation time T₁₍ᵢ₎¹, estimate a second hop relaxation time T₁₍ᵢ₎² for transmitting the message from the quantum repeater i to a quantum receiver R_{Q}, calculate a minimum composite relaxation time T₁₍ᵢ₎, where T₁₍ᵢ₎ is given by T₁₍ᵢ₎=min(T₁₍ᵢ₎¹, T₁₍ᵢ₎²), and transmit the minimum composite relaxation time T₁₍ᵢ₎ to the quantum source node.

The system further includes a quantum source computing unit operatively connected within the quantum source node, where the quantum source computing unit includes a quantum source electrical circuitry, a quantum source transceiver, a quantum source electrical memory having quantum source program instructions and at least one quantum source processor configured to execute the quantum source program instructions to receive the minimum composite relaxation time T₁₍ᵢ₎ from each quantum repeater I, select the quantum repeater with the largest composite relaxation time T_{1(best)}, and transmit a control signal to the selected quantum repeater with the largest composite relaxation time T_{1(best)} to forward the message to the quantum repeater R_{Q} during the second hop.

The quantum repeater teleporter is configured to transmit the message to the quantum repeater R_{Q} during the second hop by establishing entanglement between the at least the at least one repeater memory qubit and the at least one receiver memory qubit.

In some embodiments, the at least one quantum source processor is further configured to execute the quantum source program instructions to transmit a control signal to each non-selected quantum repeater to command the non-selected quantum repeater to sleep during the second hop.

In some embodiments, the system includes a first plurality of time varying amplitude damping channels configured to connect the quantum source node with the plurality of quantum repeaters, and a second plurality of time varying amplitude damping channels configured to connect the plurality of quantum repeaters with the receiver.

In some embodiments, the system includes an error correction unit located in each quantum repeater i, wherein the error correction unit is configured to estimate the second hop relaxation time T₁₍ᵢ₎² based on estimating a quantum outage probability

$${P}_{o u t}^{Q}$$

dependent on a quantum channel capacity C_{Q} and a transmission code rate R_{Q} of qubits per channel for the second plurality of time varying amplitude damping channels.

In some embodiments, the quantum channel capacity C_{Q} is dependent on a channel noise parameter γ, and the transmission code rate R_{Q} is dependent on a noise limit given by γₗ(R_{Q}), wherein the quantum outage probability

$${P}_{o u t}^{Q}$$

is low when the noise limit is high.

In some embodiments, the first plurality of time varying amplitude damping channels each have a different transmission code rate R¹_{Qi} for i=1, . . . , K, and the second plurality of time varying amplitude damping channels each have a different transmission code rate R²_{Qi} for i . . . , K.

In some embodiments, the error correction unit of each quantum repeater i is further configured to estimate the second hop relaxation time T₁₍ᵢ₎² by calculating a quantum hashing outage probability for each of the time varying amplitude damping channels.

In some embodiments, each time-varying amplitude damping channel is a time-varying amplitude damping Pauli twirl approximated channel, and the error correction unit of each quantum repeater i is configured to estimate a quantum hashing outage probability of each time-varying amplitude damping Pauli twirl approximated channel.

In some embodiments, the system includes each time-varying amplitude damping channel is a time-varying amplitude damping Clifford twirl approximated channel, and the error correction unit of each quantum repeater i is configured to estimate a quantum hashing outage probability of each time-varying amplitude damping clifford twirl approximated channel.

In some embodiments, the selected quantum repeater is configured to teleport the message to the quantum receiver over the amplitude damping quantum channel having the lowest quantum hashing outage probability.

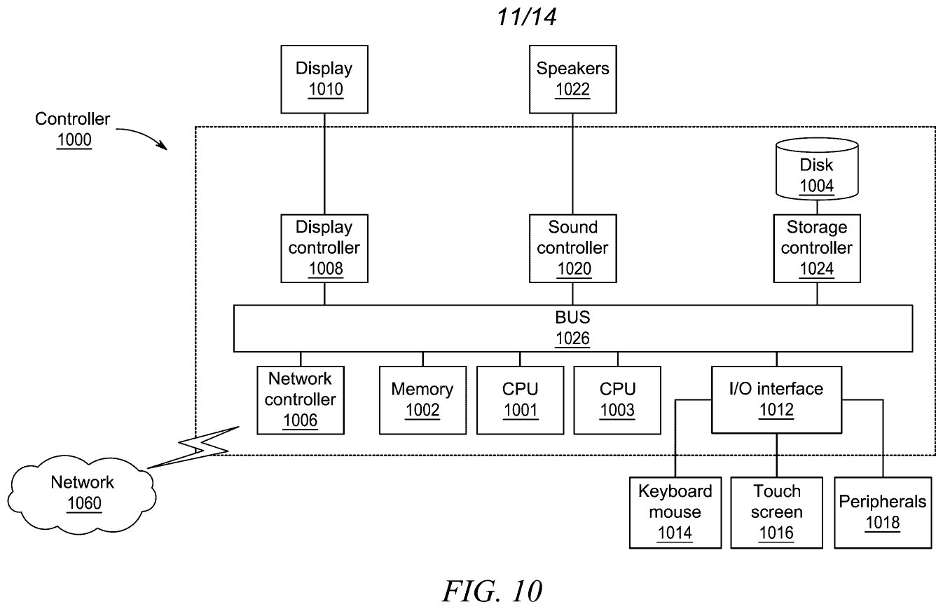

Next, further details of the hardware description of the computing environment according to exemplary embodiments is described with reference to FIG. 10. In FIG. 10, a controller 1000 is described is representative of the system 100B of FIG. 1B in which the controller is a computing device which includes a CPU 1001 which performs the processes described above/below. The process data and instructions may be stored in memory 1002. These processes and instructions may also be stored on a storage medium disk 1004 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1001, 1003 and an operating system such as Microsoft Windows 7, Microsoft Windows 10, Microsoft Windows 11,UNIX, Solaris, LINUX, Apple MAC-OS and other systems known to those skilled in the art.

The hardware elements in order to achieve the computing device may be realized by various circuitry elements, known to those skilled in the art. For example, CPU 1001 or CPU 1003 may be a Xenon or Core processor from Intel of America or an Opteron processor from AMD of America, or may be other processor types that would be recognized by one of ordinary skill in the art. Alternatively, the CPU 1001, 1003 may be implemented on an FPGA, ASIC, PLD or using discrete logic circuits, as one of ordinary skill in the art would recognize. Further, CPU 1001, 1003 may be implemented as multiple processors cooperatively working in parallel to perform the instructions of the inventive processes described above.

The computing device in FIG. 10 also includes a network controller 1006, such as an Intel Ethernet PRO network interface card from Intel Corporation of America, for interfacing with network 1060. As can be appreciated, the network 1060 can be a public network, such as the Internet, or a private network such as an LAN or WAN network, or any combination thereof and can also include PSTN or ISDN sub-networks. The network 1060 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1008, such as a NVIDIA GeForce GTX or Quadro graphics adaptor from NVIDIA Corporation of America for interfacing with display 1010, such as a Hewlett Packard HPL2445w LCD monitor. A general purpose I/O interface 1012 interfaces with a keyboard and/or mouse 1014 as well as a touch screen panel 1016 on or separate from display 1010. General purpose I/O interface also connects to a variety of peripherals 1018 including printers and scanners, such as an OfficeJet or DeskJet from Hewlett Packard.

A sound controller 1020 is also provided in the computing device such as Sound Blaster X-Fi Titanium from Creative, to interface with speakers/microphone 1022 thereby providing sounds and/or music.

The general purpose storage controller 1024 connects the storage medium disk 1004 with communication bus 1026, which may be an ISA, EISA, VESA, PCI, or similar, for interconnecting all of the components of the computing device. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

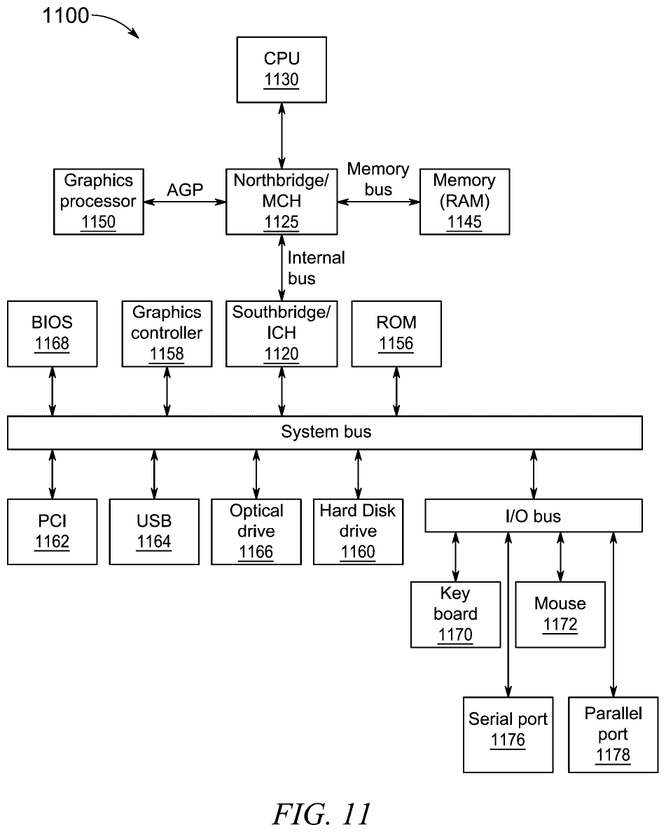

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 11.

FIG. 11 shows a schematic diagram of a data processing system, according to certain embodiments, for performing the functions of the exemplary embodiments. The data processing system is an example of a computer in which code or instructions implementing the processes of the illustrative embodiments may be located.

In FIG. 11, data processing system 1100 employs a hub architecture including a north bridge and memory controller hub (NB/MCH) 1125 and a south bridge and input/output (I/O) controller hub (SB/ICH) 1120. The central processing unit (CPU) 1130 is connected to NB/MCH 1125. The NB/MCH 1125 also connects to the memory 1145 via a memory bus, and connects to the graphics processor 1150 via an accelerated graphics port (AGP). The NB/MCH 1125 also connects to the SB/ICH 1120 via an internal bus (e.g., a unified media interface or a direct media interface). The CPU Processing unit 1130 may contain one or more processors and even may be implemented using one or more heterogeneous processor systems.

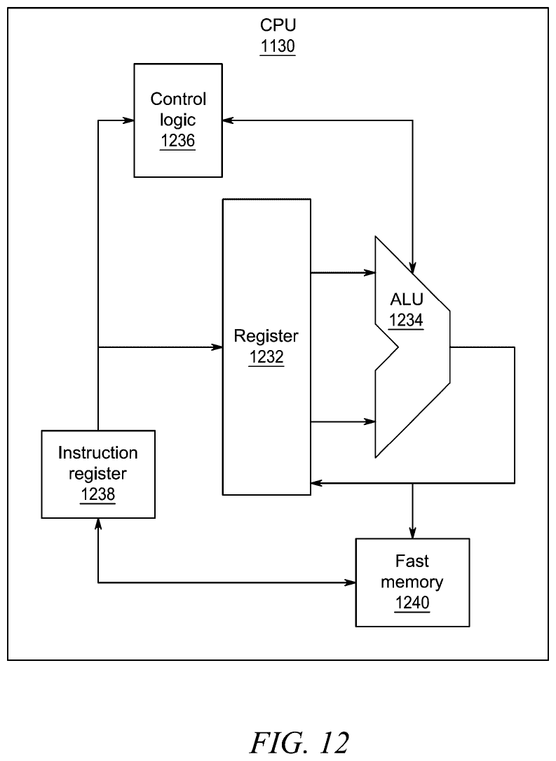

For example, FIG. 12 shows one implementation of CPU 1130. In one implementation, the instruction register 1238 retrieves instructions from the fast memory 1240. At least part of these instructions are fetched from the instruction register 1238 by the control logic 1236 and interpreted according to the instruction set architecture of the CPU 1130. Part of the instructions can also be directed to the register 1232. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1234 that loads values from the register 1232 and performs logical and mathematical operations on the loaded values according to the instructions. The results from these operations can be feedback into the register and/or stored in the fast memory 1240. According to certain implementations, the instruction set architecture of the CPU 1130 can use a reduced instruction set architecture, a complex instruction set architecture, a vector processor architecture, a very large instruction word architecture. Furthermore, the CPU 1130 can be based on the Von Neuman model or the Harvard model. The CPU 1130 can be a digital signal processor, an FPGA, an ASIC, a PLA, a PLD, or a CPLD. Further, the CPU 1130 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 11, the data processing system 1100 can include that the SB/ICH 1120 is coupled through a system bus to an I/O Bus, a read only memory (ROM) 1156, universal serial bus (USB) port 1164, a flash binary input/output system (BIOS) 1168, and a graphics controller 1158. PCI/PCIe devices can also be coupled to SB/ICH 1188 through a PCI bus 1162.

The PCI devices may include, for example, Ethernet adapters, add-in cards, and PC cards for notebook computers. The Hard disk drive 1160 and CD-ROM 1166 can use, for example, an integrated drive electronics (IDE) or serial advanced technology attachment (SATA) interface. In one implementation the I/O bus can include a super I/O (SIO) device.

Further, the hard disk drive (HDD) 1160 and optical drive 1166 can also be coupled to the SB/ICH 1120 through a system bus. In one implementation, a keyboard 1170, a mouse 1172, a parallel port 1178, and a serial port 1176 can be connected to the system bus through the I/O bus. Other peripherals and devices that can be connected to the SB/ICH 1120 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

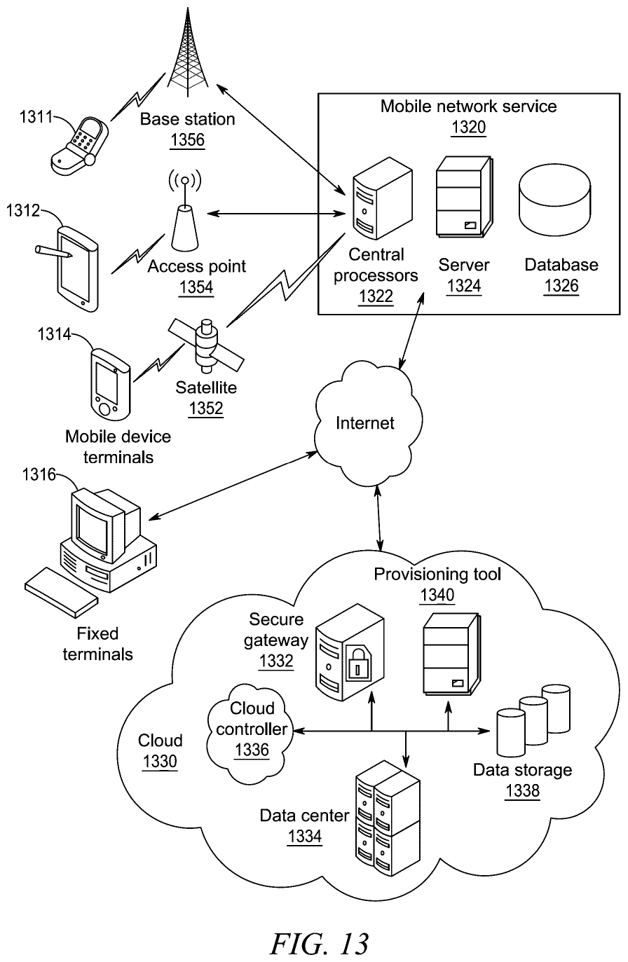

The functions and features described herein may also be executed by various distributed components of a system. For example, one or more processors may execute these system functions, wherein the processors are distributed across multiple components communicating in a network. The distributed components may include one or more client and server machines, such as cloud 1330 including a cloud controller 1336, a secure gateway 1332, a data center 1334, data storage 1338 and a provisioning tool 1340, and mobile network services 1320 including central processors 1322, a server 1324 and a database 1326, which may share processing, as shown by FIG. 13, in addition to various human interface and communication devices (e.g., display monitors 1316, smart phones 1310, tablets 1312, personal digital assistants (PDAs) 1314). The network may be a private network, such as a LAN, satellite 1352 or WAN 1354, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A method for dual-hop quantum communication, comprising:
transmitting during a first hop, by a quantum source node teleporter, a message to a plurality K of quantum repeaters over a plurality of time varying amplitude damping channels, wherein the message includes at least one superconducting qubit;
receiving, by each quantum repeater i, where i=1, . . . , K, the message from the quantum source node;
measuring, by each quantum repeater i, a first hop relaxation time T₁₍ᵢ₎¹;
estimating, by each quantum repeater i, a second hop relaxation time T₁₍ᵢ₎² for transmitting the message from the quantum repeater i to a quantum repeater R_{Q};
calculating, by each quantum repeater i, a minimum composite relaxation time T₁₍ᵢ₎, where T₁₍ᵢ₎ is given by T₁₍ᵢ₎=min(T₁₍ᵢ₎¹, T₁₍ᵢ₎²);
transmitting, by each quantum repeater i, the minimum composite relaxation time T₁₍ᵢ₎ to the quantum source node;
determining, by the quantum source node, the largest composite relaxation time T_{1(best)} of the K quantum repeaters, where T_{1(best)} is given by T_{1(best)}=max(T₁₍ᵢ₎) for i=1, . . . , K;
selecting, by the quantum source node, the quantum repeater with the largest composite relaxation time T_{1(best)};
transmitting, by the quantum source node, a control signal to the selected quantum repeater with the largest composite relaxation time T_{1(best)} to forward the message to the quantum repeater R_{Q} during the second hop; and
transmitting, by the selected quantum repeater, the message to the quantum repeater R_{Q} during the second hop.

2. The method of claim 1, further comprising:
transmitting, by the quantum source node, a control signal to each non-selected quantum repeater to sleep during the second hop.

3. The method of claim 1, wherein estimating the second hop relaxation time T₁₍ᵢ₎² comprises estimating, by an error correction unit located in each quantum repeater i, a quantum outage probability
$${P}_{o u t}^{Q}$$
based on a quantum channel capacity C_{Q} and a transmission code rate R_{Q} of qubits per channel.

4. The method of claim 3, wherein:
the quantum channel capacity C_{Q} is dependent on a channel noise parameter γ; and
the transmission code rate R_{Q} is dependent on a noise limit given by γₗ(R_{Q}), wherein the quantum outage probability
$${P}_{o u t}^{Q}$$
is low when the noise limit is high.

5. The method of claim 1, wherein estimating the second hop relaxation time T₁₍ᵢ₎² comprises determining, by each quantum repeater i, a quantum hashing outage probability for each of the time varying amplitude damping channels.

6. The method of claim 5, wherein:
each time-varying amplitude damping channel is a time-varying amplitude damping Pauli twirl approximated channel; and
estimating, by each quantum repeater i, the quantum hashing outage probability of each time-varying amplitude damping Pauli twirl approximated channel.

7. The method of claim 5, wherein:
each time-varying amplitude damping channel is a time-varying amplitude damping Clifford twirl approximated channel; and
estimating, by each quantum repeater i, the quantum hashing outage probability of each time-varying amplitude damping Clifford twirl approximated channel.

8. The method of claim 5, further comprising:
transmitting, by the selected quantum repeater, the message to the quantum receiver over the amplitude damping quantum channel having the lowest quantum hashing outage probability.

9. The method of claim 1, further comprising:
transmitting, during the first hop, by the quantum source node teleporter, the message to the plurality K of quantum repeaters over the plurality of time varying amplitude damping channels by establishing entanglement between the at least one superconducting qubit and the at least one repeater memory qubit.

10. The method of claim 1, further comprising:
transmitting, by a repeater transporter of the selected quantum repeater, the message to the quantum repeater R_{Q} during the second hop by establishing entanglement between the at least one repeater memory qubit and at least one receiver memory qubit.

11. A system for dual-hop quantum communication, comprising:
a quantum source node;
a source encoder operatively connected within the quantum source node, wherein the encoder is configured to encode a message including at least one superconducting qubit;
a plurality K of quantum repeaters, wherein each quantum repeater i, where i=1, . . . , K, includes at least one repeater memory qubit and a quantum repeater computing unit;
a quantum source node teleporter operatively connected within the quantum source node, wherein the quantum source node teleporter is configured to transmit the message by establishing entanglement between the at least one superconducting qubit and the at least one repeater memory qubit;
a receiver configured with at least one receiver memory qubit,
wherein the quantum repeater computing unit of each quantum repeater i includes a quantum repeater electrical circuitry, a quantum repeater transceiver, a quantum repeater teleporter, a quantum repeater electrical memory having quantum repeater program instructions and at least one quantum repeater processor configured to execute the quantum repeater program instructions to:
measure a first hop relaxation time T₁₍ᵢ₎¹;
estimate a second hop relaxation time T₁₍ᵢ₎² for transmitting the message from the quantum repeater i to a quantum receiver R_{Q};
calculate a minimum composite relaxation time T₁₍ᵢ₎, where T₁₍ᵢ₎ is given by T₁₍ᵢ₎=min(T₁₍ᵢ₎¹, T₁₍ᵢ₎²);
transmit the minimum composite relaxation time T₁₍ᵢ₎ to the quantum source node;
a quantum source computing unit operatively connected within the quantum source node, wherein the quantum source computing unit includes a quantum source electrical circuitry, a quantum source transceiver, a quantum source electrical memory having quantum source program instructions and at least one quantum source processor configured to execute the quantum source program instructions to:
receive the minimum composite relaxation time T₁₍ᵢ₎ from each quantum repeater i;
select the quantum repeater with the largest composite relaxation time T_{1(best)}; and
transmit a control signal to the selected quantum repeater with the largest composite relaxation time T_{1(best)} to forward the message to the quantum repeater R_{Q} during the second hop,
wherein the quantum repeater teleporter is configured to transmit the message to the quantum repeater R_{Q} during the second hop by establishing entanglement between the at least the at least one repeater memory qubit and the at least one receiver memory qubit.

12. The system of claim 11, wherein the at least one quantum source processor is further configured to execute the quantum source program instructions to transmit a control signal to each non-selected quantum repeater to command the non-selected quantum repeater to sleep during the second hop.

13. The system of claim 11, further comprising:
a first plurality of time varying amplitude damping channels configured to connect the quantum source node with the plurality of quantum repeaters; and
a second plurality of time varying amplitude damping channels configured to connect the plurality of quantum repeaters with the receiver.

14. The system of claim 13, further comprising:
an error correction unit located in each quantum repeater i, wherein the error correction unit is configured to estimate the second hop relaxation time T₁(i)² based on estimating a quantum outage probability
$${P}_{o u t}^{Q}$$
dependent on a quantum channel capacity C_{Q} and a transmission code rate R_{Q} of qubits per channel for the second plurality of time varying amplitude damping channels.

15. The system of claim 14, wherein:
the quantum channel capacity C_{Q} is dependent on a channel noise parameter γ; and
the transmission code rate R_{Q} is dependent on a noise limit given by γₗ(R_{Q}), wherein the quantum outage probability
$${P}_{out}^{Q}$$
is low when the noise limit is high.

16. The system of claim 15, wherein:
the first plurality of time varying amplitude damping channels each have a different transmission code rate R¹_{Qi} for i=1, . . . , K; and
the second plurality of time varying amplitude damping channels each have a different transmission code rate R²_{Qi} for i=1, . . . , K.

17. The system of claim 13, wherein the error correction unit of each quantum repeater i is further configured to estimate the second hop relaxation time T₁₍ᵢ₎² by calculating a quantum hashing outage probability for each of the time varying amplitude damping channels.

18. The system of claim 17, wherein:
each time-varying amplitude damping channel is a time-varying amplitude damping Pauli twirl approximated channel; and
the error correction unit of each quantum repeater i is configured to estimate a quantum hashing outage probability of each time-varying amplitude damping Pauli twirl approximated channel.

19. The system of claim 17, wherein:
each time-varying amplitude damping channel is a time-varying amplitude damping Clifford twirl approximated channel; and
the error correction unit of each quantum repeater i is configured to estimate a quantum hashing outage probability of each time-varying amplitude damping Clifford twirl approximated channel.

20. The system of claim 17, wherein the selected quantum repeater is configured to teleport the message to the quantum receiver over the amplitude damping quantum channel having the lowest quantum hashing outage probability.
